(19) United States
(12) Patent Application Publication
(10) Pub. No.: US 2003/0235408 A1
(43) Pub. Date: Dec. 25, 2003

(54) Optical disk drive, computer system and methods of operation

(75) Inventors: Kelan Craig Silvester, Portland, OR (US); Randy Paul Stanley, Aptos, CA (US)

Correspondence Address: Walter D. Fields, MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/183,875

(22) Filed: Jun. 25, 2002

(51) Int. Cl. H04N 5/781

(52) U.S. Cl. 386/126

(57) ABSTRACT

An optical disk drive may be operable to operate with a rotational speed(s) less than a maximum operable speed. A computer operable with the optical drive or the optical drive itself may identify and recognize a policy or transfer application for the optical drive. The optical drive may then be set for a configuration to select a rotational speed dependent on the determined policy or transfer application.

### BACKGROUND

A computer system may use an optical disk drive to access large amounts of data on an optical disk. The optical disk may contain data for a software application, data for a large data base or simply data for audio or video play and may comprise a variety of different forms and formats.

For example, a CD-ROM (Compact Disk Read-Only Memory) may refer to a disk medium typical for software data to be executed by a computer system or data for a data base application of the computer.

A CD (compact disk), on the other hand, conventionally may be interpreted as an optical disk medium for storage of data representative of images and/or audio. Data of the may be optically read for presentation, display or play to a user for consumption.

Advancements in optical storage medium have further led to DVD's (Digital Versatile/Video Disk), an optical storage medium of capacity and bandwidth greater than CD's and CD-ROMs. For example, a DVD may retain information of a full-length film, which might be formatted with an MPEG (Moving Picture Experts Group) video format.

A drive to spin and read an optical disk may be referenced as an optical disk drive. Optical disk drives may be characterized with a speed factor that, conventionally, has been defined with reference to music. A speed factor of 1X, for example, may reference a drive speed to allow reading of music data for real-time music reproduction. In this context, the 1X speed may provide for reading of data to establish a data transfer rate of about 150 kilobytes per second. But as the optical disk applications have moved beyond music, and as computer operating speeds have increased, the 1X drives seem to restrict the performances levels and efficiencies of computer systems.

Accordingly, manufacturers push to improve rotational speeds of optical disk drives. Some drives today provide for high rotational speeds, for example, 32X. These improvements in drive speed, in some applications, may provide particularly effective improvements in system performance. In other words, dependent on the particular processing application, an improvement in drive speed may translate substantially directly to a similar improvement in system performance, particularly for applications requiring file transfers. The increase in rotational speed, thus, provides a mechanism to transfer data to/from the optical disk at a higher rate. But maximizing disk speed may not always be the ultimate objective.

### BRIEF DESCRIPTION OF THE DRAWINGS

The present disclosure may be best understood with reference to the accompanying drawings, wherein:

FIG. 1 is a schematic block diagram of an optical disk drive;

FIG. 2 is block diagram of a computer system with an optical disk drive;

FIG. 3 is a simplistic layer diagram representative of the software and/or hardware environment between the optical disk drive and another subsystem;

FIG. 4 is a simplified pictorial illustration of an application window to enable a user to set a configuration policy of a computer and optical disk drive;

FIG. 5 is a flow diagram showing a procedure to determine a rotational speed for an optical disk drive; and

FIG. 6 is another flow diagram showing a procedure to determine a rotational speed of an optical disk drive.

### DETAILED DESCRIPTION

In the following description, numerous specific details are set forth to provide an understanding of exemplary embodiments of the present invention. It will be understood, however, that alternative embodiments may comprise sub-combinations of the disclosed exemplary embodiments.

Additionally, readily established circuits of the exemplary embodiments may be disclosed in simplified form (e.g., block diagram style) to avoid obscuring an essence of the embodiments with excess detail. Likewise, to aid a clear and precise disclosure, the description of their operations may similarly be simplified when persons of ordinary skill in this art may understand their operations by way of the drawings and present disclosure.

Conventional computers, such as laptops, may exchange data with an optical drive using a specified rotational speed of the optical drive. In other words, when a computer begins a procedure to retrieve data from the optical disk, the drive is spun to its specified performance speed, such as 24X. When the disk is no longer being accessed, the optical drive may be turned-off. Accordingly, the conventional drive may be off or spun to its maximum performance speed.

In accordance with exemplary embodiments of the present invention, an optical disk may be spun and accessed while operating at rotational speeds less than a maximum spin-rate. A computer or optical disk drive may identify and recognize a configuration policy or data transfer application for the optical disk drive or for a computer system. Depending on the policy or application, it may then recognize that the optical disk does not have to be spun at its maximum speed and may be spun at a speed less than its maximum available speed. Responsive to this recognition, the disk drive may configure its settings so as to spin-up to an optical disk speed(s) less than its maximum available speed. In other words, the drive might, thus, be spun-up to only 1X, e.g., when in fact it may be capable of 24X operation.

For example, if data is to be transferred from the optical drive for real-time entertainment (e.g., real-time video/audio streaming for human consumption), then the disk drive, in accordance with a particular embodiment, may recognize the real-time, entertainment-type data streaming application or an instruction thereof and spin the optical disk at a speed less than its maximum available speed. The data transfer application to stream video/audio data real-time may be recognized and used to select an optical disk drive speed of 1X, e.g., instead of a higher available spin rate of 24X. It may be further noted that absent a large media cache or buffer for buffering of graphics or audio information, the extra speed and data transfer rate otherwise offered by an optical drive (e.g., maximum speed 24X) may be viewed as excessive or wasted.

In consideration of noise, it may be understood that an optical disk drive generates a certain level of noise while spinning. This noise may seem excessively loud under certain environmental circumstances. For example, when viewing or listening to a movie, a user may not wish to hear drive noise. Therefore, in accordance with another embodiment of the present invention, a quite mode of operation may be specified, e.g., by a user, to specify a more suitable operation, which additionally may be used under pre-established environmental circumstances. The optical disk drive may then respond to this specified low-noise policy and may configure itself to spin-up at speed(s) less than its maximum available speed.

Further, a computer may specify a configuration policy to preserve energy. For example, a laptop computer may specify a configuration policy to use a low operating clock frequency so as to conserve energy when operating with a battery power source. Accordingly, in another embodiment, the computer or drive may recognize this configuration policy and additionally respond to configure the optical disk drive to use a rotational speed less than its maximum available speed. This may further help to conserve energy and extend the battery longevity.

The “access” of an optical disk drive may refer to operations for reading data of an optical disk. It will be understood, however, that the optical disk drive might also be spun to assist writing of data. Accordingly, “access,” as used herein for other embodiments of the present invention, may refer to writing of data into the optical disk. For example, the optical disk drive may determine a configuration policy favoring low noise operations or operations for extending battery life. Responsive to such configuration policy, the optical drive may be configured to spin with a rotational speed less than its maximum available speed when writing data therein.

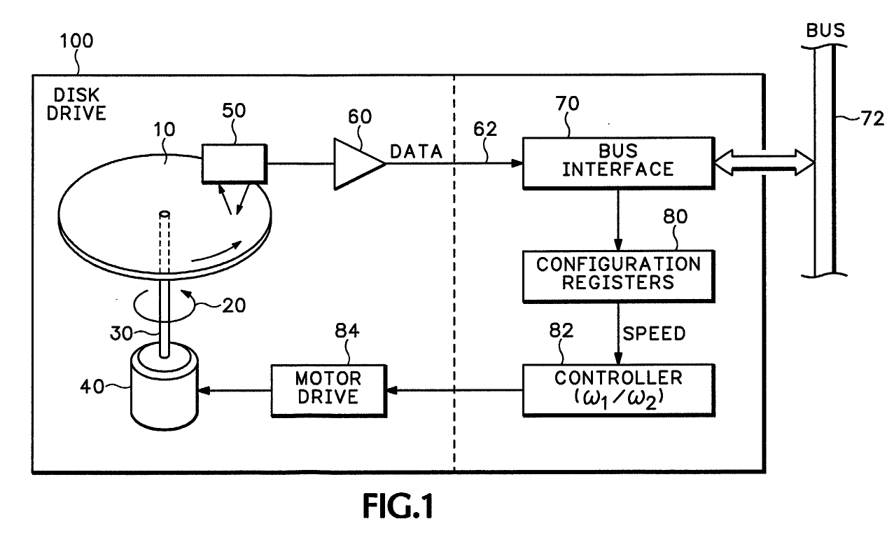

Referencing FIG. 1, an optical disk drive 100 of an exemplary embodiment may comprise an optical sensor and buffer 50,60 respectively to sense data of optical disk 10. The amplifier may drive data line 62 for transfer of data for presentation to bus 72 via bus interface 70.

Registers 80 may receive configuration information (e.g., from bus interface 70 or otherwise) to configure operability of the optical drive. For example, the configuration registers may comprise ATA registers operable in accordance with an ATA/ATAPI (advanced technology attachment/ATA-packet interface) protocol. Such standard ATA/ATAPI-6, e.g., draft T13/1410D for Revision 3A of Dec. 14, 2001, is available from ANSI and is hereby incorporated by reference. The ATA registers, conventionally, may select ATA/ATAPI configurations for the optical drive and may establish how the drive may handle and coordinate memory access commands.

In accordance with a particular embodiment of the present invention, a portion of configuration registers 80 may be dedicated to contain rotational-information that may be used to select from a plurality of available rotational speeds of the optical disk drive. Motor controller 82 may, therefore, drive (via motor drive 84) motor 40 dependent on the rotational-information of the configuration registers. Motor 40 may rotate spindle 30 and optical disk 10 per the selected speeds as established by the rotational governor (e.g., a collective reference to registers 80, motor controller 82 and motor drive 84). Accordingly, as may be used herein, rotational governor may reference such devices as may be operable to select the operable speed of the optical disk.

Although ATA command registers and circuitry may not be specifically illustrated in the schematic of FIG. 1, it will be understood that the bus interface and registers of the disk drive 100 (e.g., of an ATA/ATAPI standard) may include such command registers and circuitry as conventionally known to enable or disable the drive responsive to receiving commands to access the storage medium. In addition to such on/off enablement capability, a rotational governor, in accordance with this exemplary embodiment, may select or determine a speed by which to drive the motor (when enabled) for rotation of an optical disk—e.g., ω1 or ω2.

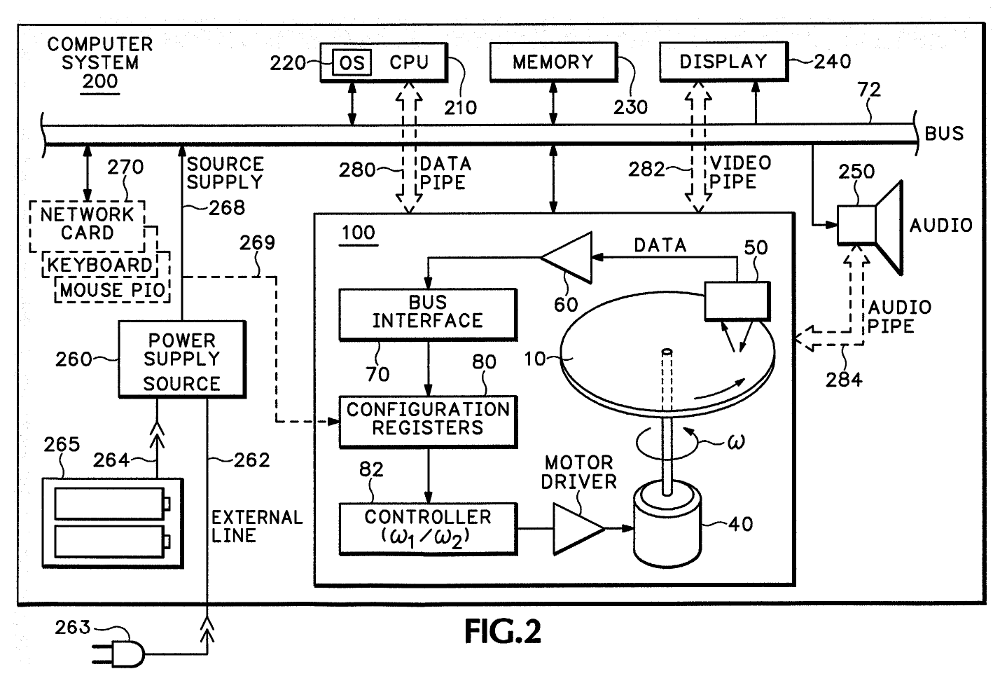

In accordance with another embodiment of the present invention, referencing FIG. 2, a computer system 200 may comprise an optical disk drive 100, e.g., as previously described relative to FIG. 1. For example, a laptop computer may include a processor (or CPU) 210 coupled for communication with other devices via bus 72. CPU 210 may send/receive data to/from a variety of different subsystems, such as, e.g., memory 230, graphics controller 240, network interface 270 and (e.g., DVD/CD-ROM) optical disk drive 100. The computer system may include other subsystems, including but not limited to, e.g., a mouse, keyboard, programmable I/O device, bridging circuit, etc.

Although described above as communicating with CPU 210, the optical disk drive, in alternative embodiments, may also be operable to communicate with subsystems other than the CPU. In such type of data transfer application, the optical disk drive may operate “autonomously”—i.e., absent CPU intervention. During such autonomous operations, the optical disk drive may sense data of an optical disk for transfer directly to, e.g., a graphics or audio subsystem 240,250. During a configuration or an initialization phase for enabling such autonomous transfer application, the subsystems might send data to the optical disk drive to help it set-up its subsystem layers (Application, Driver, Interface, etc.) and to establish the logical links therebetween. For example, certain information may be exchanged between the subsystems to configure logical video pipe 282 or logical audio pipe 284 between the optical disk drive and the graphics controller 240 or audio controller 250.

As used herein, the graphics and audio subsystems may be referenced simply as video/audio device(s). Thus, video/audio may reference processes of video and/or audio applications for graphics, video and/or audio presentation(s) together or singularly.

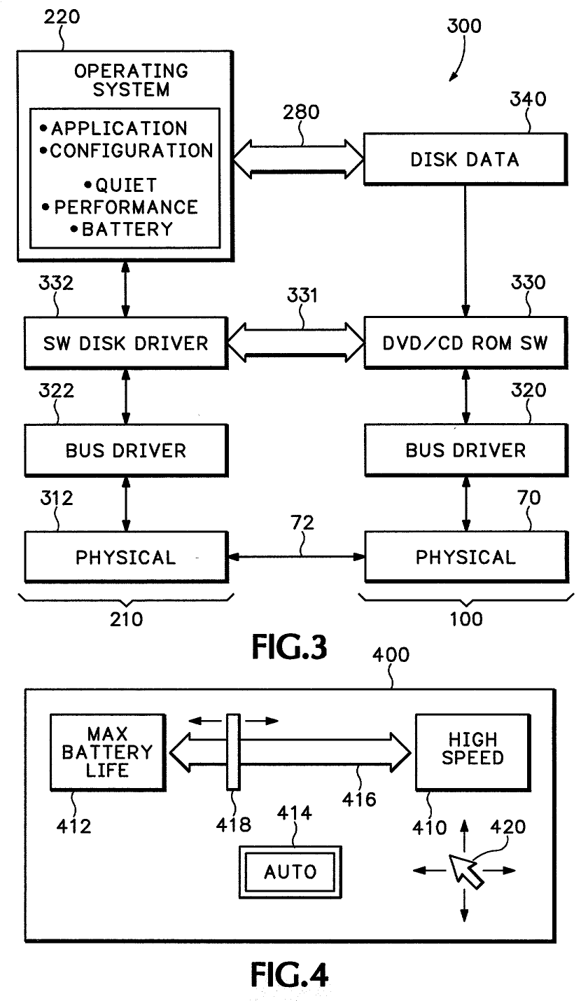

Referencing FIGS. 2-3, operating system 220 of CPU 210 may initiate and execute various processing applications (e.g., word processing, internet browsing, document printing, data base processing, etc.). In such applications, there may be a need for the operating system to download software or data from an optical disk. The operating system may then send software and/or data information to the optical drive 100 by which to initiate and perform a data transfer.

Referencing the partial system layers 300 of the simplified diagram of FIG. 3, operating system 220 may begin a predetermined application such as a data base operation. The software module of the data base application may coordinate access to the optical disk by way of other software modules such as a software driver 332 (which may be pre-configured within the computer's operating system or system utilities). The software driver may link with lower interfacing layer 322 and physical layer 312 to enable propagation of, e.g., access requests across bus 72 to optical drive 100. Complimentary layer structures 70,320 at the optical drive may then propagate the application information to the drive's upper layers (i.e., application and data layers 330,340). These types of communications between the CPU and optical drive may therefore be viewed as occurring across logical pipes 280,331 between the respective peer layers (e.g., application or data layers) of the different subsystems.

With reference to these working models of FIGS. 1 and 2, configuration policies and application types may influence operations of the CPU and/or optical drive. The CPU's operating system 220 may send configuration information to the optical disk drive (e.g., across pipe 331 or 280) and the optical drive may select its rotational speed accordingly. Alternatively, driver software at the drive itself may establish the configuration of the optical disk drive.

For example, the drive 100 may be operable to determine a battery source 265 of the power supply 260 via control line 269. Responsive to this control line, the drive 100 may establish a configuration setting directly rather than dependent on information from the CPU.

Likewise in further embodiments, the optical drive may directly receive a lid-down control signal to indicate that a lid of a laptop is closed. If an optical disk is then placed in the optical drive 100, the optical drive may respond by initiating a data transfer for an entertainment type application. The entertainment-type application, in turn, may cause selection of the drive's lower rotational speed. Such application, therefore, may thus be described as having been initiated autonomously by the optical drive. Responding to the launching of the application, the optical drive may transfer data of the optical disk to a bus for use by, e.g., an audio controller or an external video/audio system that may be coupled to the bus. For example, in one embodiment, an external video system may be coupled directly to the bus. In another embodiment, the video system may be coupled indirectly to the bus via a bridging circuit that interfaces the bus.

Further referencing FIG. 2, in accordance with another embodiment, computer system 200 may comprise a power supply 260 operable to convey along line 268 information of its power source—e.g., whether it is being powered by a battery 265 or from an external line 262. If powered from an external line, the drive may select operability at fall speed. If powered from a battery, the lower speed may be selected.

Referencing FIGS. 2-4, the computer system 200 may run a routine of the CPU's operating system 220, which may enable a user to select a performance configuration policy for the computer system. The routine may display a window 400 on a visual display 240. The window 400 may include, e.g., a maximum battery life icon/button 412 and a high speed icon/button 410. The user may select, e.g., via cursor 420, either performance level. In a further embodiment, the configuration window may also include an auto button 414, or additionally, a variable scale 416 and visual slider bar 418. The user may operate a user interface device (e.g., mouse, mouse buttons, knobs, keyboard, etc., singly or in combination) to indicate a select configuration policy.

The policy settings, conventionally, may be used to establish an operational frequency for a clock of the CPU. In exemplary embodiments of the present invention, the configuration policy may further be used to set or define flags, variables, conditions, control signals or the like, that may be directed to procedures of the optical disk drive as may be associated with selecting and establishing a rotational speed therefore.

In some embodiments, the configuration information may be saved, e.g., within memory of CPU 210, programmable memory 230 outside the CPU, system configuration registers, and/or configuration registers 80 of optical drive 100. In other embodiments, the optical disk 10 may comprise a read/write medium, and the configuration information may be written and retained at a predetermined location thereof.

As described herein, various procedures of the computer system or optical drive may be implemented as a program and may be described with reference to interconnected modules that may be individually or collectively referenced as software. It will be understood, however, that these modules may be aggregated within a single program or alternatively across boundaries of various programs and/or devices (e.g., CPU's operating system 220 and software drivers 332,330 for the optical drive of FIG. 3). The software modules may be implemented individually or in combination with others. Additionally, these programs may be programmed within a computer-readable medium that may comprise a single memory or multiple memories. Various portions, modules or features may reside in separate memories, subsystems or even separate machines.

Additionally, procedures of exemplary embodiments may be described as a series of routines implemented by a processor programmable and operable through a series of commands of the routines. For example, the processor may comprise a digital computer or like device, such as a general-purpose computer configurable by a computer program stored within the computer. Alternately, in may be understood that the procedures, or a portion thereof, may be implemented by a state machine of, e.g., an Application Specific Integrated Circuit.

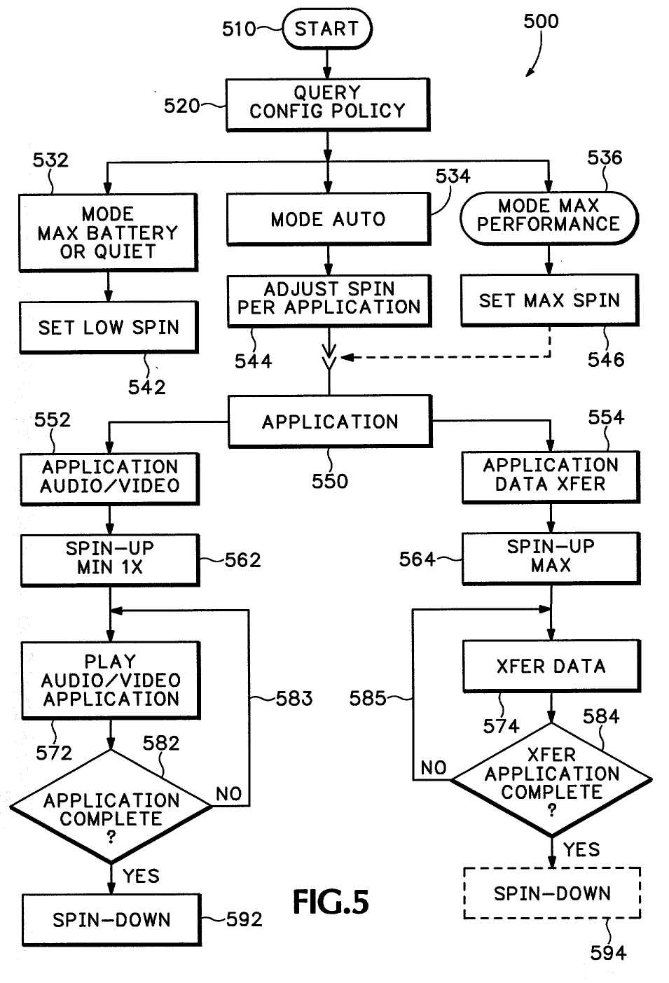

Further referencing FIG. 5, program 500 may be used for operation of an optical drive in accordance with exemplary embodiments of the present invention. Modules 520-546 may be viewed as optional procedures that augment the remainder procedures 550-594 or visa versa.

Initiation 510 of procedure 500 may lead to a query 520 of the configuration policy of a computer system. The configuration policy, for example, may specify, e.g., one of three modes—i.e., maximum battery life, an auto mode or maximum performance. These modes, as mentioned above, are usually associated with and applied to the processor's clock operation. The maximum battery life policy may configure the processor to use a low operating frequency; while the maximum performance policy may configure the processor to use a high operating clock frequency. The auto mode may allow the processor to use the low frequency for some applications, while popping-up to the high frequency on an as need basis.

Likewise, in accordance with an embodiment of the present invention, the determined configuration policy 532,534,536 may lead to different operating procedures of the optical drive. The maximum battery life policy may lead to setting the optical drive for a low spin configuration 532,542, in which case, the drive may use its lower rotational frequency (e.g., 1X). In this configuration, the computer system does not care how fast a file is copied.

Alternatively, the max performance policy may lead to setting the optical drive for a maximum spin configuration 536,546. The computer system policy may then choose not to compromise any performance. Finally, the automatic, configuration policy may configure 534,544 the optical drive to establish its select rotational speed (ω1/ω2 based on its particular application. In this sense, the optical drive may be viewed as establishing different rotational mode selections in parallel and similar to the processor mode selections.

In a further embodiment, the optical disk drive may default to a configuration to select its lower rotational speed when launching applications absent interactions with an operating system or when the computer operating system is not active.

As described above, the configuration policy may balance or compromise battery life with system performance. In other embodiments of the present invention, the configuration policy may also encompass a noise level adjustment. In this further embodiment, a low noise configuration policy may direct configuration determinations and settings 532′,542′ for selecting the low spin operation of the optical drive.

In a further embodiment of the present invention, referencing FIG. 5, a routine 550-594 may establish drive speed operations dependent on the data transfer or access application. First, an application may be determined 550. In some embodiments, the application may be specified from a requesting device—i.e., from a processor 210 of FIGS. 2-3. Alternatively, a software driver 330 of the optical driver may specify the application, which, in turn, may determine the type of application from the type of access request and/or from the type of data associated with the optical disk.

Upon determining a real-time entertainment type application 552, such as real-time video/audio data streaming, the drive may be configured to spin-up to a rotational speed (e.g., 1x) less than its maximum available speed. The application may then proceed to transfer and play 572 the retrieved data. After the application is complete 582, the optical drive may then be spun-down 592.

Alternatively, upon determining a data transfer application 554, e.g., of a data base application, the drive may be spun to a maximum spin rate 564 and data transfer performed until complete 574,584. After completion of the application for data transfer, the drive may be spun-down 594.

In certain contexts, an application for data transfer may include a series of separate data string transfers. An application software routine (or layer) may administer when conclusion of the application may occur. The optical disk drive may, therefore, continue spinning at its established speed during short intervals of no data flow until conclusion of transfer may be specified by the application layer or routine.

Typically, the operating system of the CPU may administer the policy for the application. Alternatively, the software driver for the optical drive may establish an application conclusion, e.g., based on a predetermined signature of a procedure that may mark conclusion of the associated application.

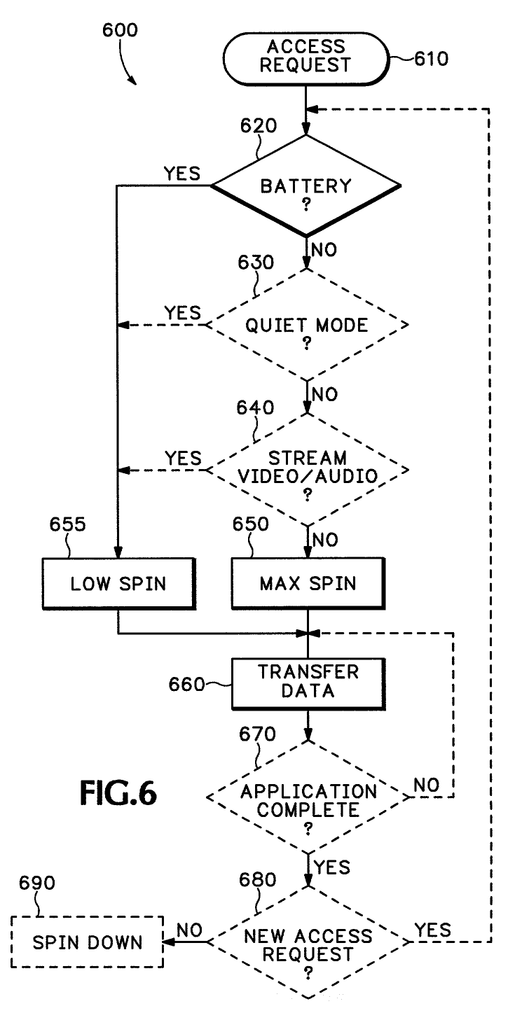

In accordance with another embodiment, referencing FIG. 6, a procedure 600 may start 610 an access request, for example, and the disk drive 100 may determine, or the software drivers of the disk drive (332 or 330 of FIG. 3) may determine whether or not the disk drive is being powered by a battery. The determination may be based on a control signal of control input 269 (FIG. 2), data of a configuration registers 80, data of a configuration registers of the computer system or data of operands or variables passed over from another software module of the central processor.

If it determines that the power source is not a battery and that it is being powered from an external line, the optical disk drive may configure 650 itself to spin at its maximum speed. If the query 620 determines a battery, the drive may be configured for the lower speed 655.

As shown in FIG. 6, additional criteria may also be used to determine the rotational speed. Queries may check for, e.g., a quiet mode 630 configuration policy and/or the type of the data of the transfer or application 640. If the query determines an application for real-time video/audio entertainment or a configuration policy for a quiet mode of operation, then the optical disk drive may be configured for its lower rotational speed 655. Otherwise, it may be configured to use its higher rotational speed 650.

Continuing with further reference to FIG. 6, the optical disk drive may then transfer data 660 while spinning the disk at its selected speed. Again, once the application is concluded, the disk may be spun-down 670,690.

In a further embodiment, another inquiry may check whether a new access request has been received 680 before allowing the disk to spin-down 690. Additionally, the inquiry for a new access request may be left pending for a predetermined period of time, before continuing forward to initiate the disk spin-down 690.

In the present document, descriptors “first” or “second” may have been used for description clarity. Depending on their context or sub-context, these descriptors may be understood to be used merely for convenience, without necessarily implying that mention of a “second” should dictate a “first”.

It will be apparent to those skilled in this art that the particular embodiments illustrated or described herein are exemplary and that various changes and modifications may be made thereto as become apparent upon reading the present disclosure. Accordingly, such changes and modifications shall be deemed to fall within the scope of the appended claims.

What is claimed is:

1. An optical disk drive comprising:
a spindle operable to spin a disk; and
a controller operable to select a rotational speed for the spindle.

2. An optical disk drive according to claim 1, the controller to select from one of a first and a second rotational speed, the second rotational speed faster than the first rotational speed.

3. An optical disk drive according to claim 2, further comprising:
a sensor to sense data; and
a circuit to transfer the data and to determine a type of the data transfer;
the controller to establish the rotational speed selection dependent on the circuit's determination of the type of data transfer.

4. An optical disk drive according to claim 2, further comprising a module to determine if an application for access of the disk is for an audio/video application;
the controller responsive to the module to set the rotational speed of the spindle to the first speed dependent on the module's determination of an audio/video application.

5. An optical disk drive according to claim 4, in which the module is to determine if the application for access of the disk is associated with streaming of audio/video data; and
the controller to set the rotational speed to a rate sufficient to maintain the streaming for real-time presentation of the audio/video.

6. An optical disk drive according to claim 1, further comprising:
a motor to spin the spindle; and
a power supply to power at least the motor, the power supply operable to receive power from at least one source of the group consisting of a battery and an external power line;
the controller to establish the rotational speed selection based on the source of the power supply.

7. An optical disk drive according to claim 6, in which:
the controller is operable per a software driver to receive and process data of the optical disk and to determine a type of data transfer; and
the controller is further operable to select a rotational speed based on both the determination of the type of data transfer and the source of the power supply.

8. An optical disk drive according to claim 7, in which the controller is further responsive to the software driver to set a rotational speed for the motor to a lower of two speeds dependent on at least one of determining an audio/video data streaming application or determining that the power source comprises a battery.

9. An optical disk drive according to claim 1, further comprising:
a configuration register to receive data;
the controller to set a rotational speed of the spindle based on data of the configuration register.

10. An optical disk drive according to claim 9, the register to contain information representative of a type of power source and of a type of data media of a disk to be spun by the spindle; and
the controller responsive to the register content to set the rotational speed of the spindle based on the type of power source and the type of data media represented thereby.

11. An optical disk drive according to claim 10, the register further to contain information representative of an operating mode; and
the controller further responsive to the registers to base its setting of the rotational speed upon the operating mode established within the registers.

12. A method of operating an optical disk drive, comprising:
spinning an optical disk; and
selecting a spin-rate for the spinning of the optical disk from at least first and second spin-rates.

13. A method according to claim 12, further comprising:
reading data of the optical disk; and
making the spin-rate selection depend on an application associated with the reading.

14. A method according to claim 13, in which the selecting the spin-rate comprises:
using the first spin-rate if the application associated with the reading is data transfer; and
using the second spin-rate if the application associated with the reading is streaming of audio or video data.

15. A method according to claim 13, further comprising determining a power source of the optical drive;
the selecting to select a spin-rate based on both the determination of the power source and the application associated with the reading.

16. A method according to claim 15, in which the selecting uses a lower of the first and second spin-rates when either the application is determined to be real-time audio/video data streaming or the power source is determined to be a battery.

17. A method according to claim 12, further comprising:
determining a configuration policy of an operating system; and
affecting the selecting of the spin-rate based on the configuration policy determination.

18. A method according to claim 17, in which the selecting uses a low spin-rate when the determination determines at least one of a configuration policy for a maximum battery life or a configuration policy for quiet operation.

19. A method of operating a computer system, comprising:
requesting access of an optical disk;
determining an application associated with the access request; and
setting a spin-rate of the optical disk dependent on the application determined.

20. A method according to claim 19, in which the affecting may select a spin-rate for the optical disk from at least first and second different spin-rates.

21. A method according to claim 20, in which:
the determining determines whether the application is associated with streaming of at least one of audio and video data; and
the affecting to establish the first spin-rate dependent on the determining identifying an application of audio/video data streaming.

22. A method according to claim 20, further comprising:
determining a configuration policy of the computer operating system; and
the affecting comprises:
using the second spin-rate if the determining identifies a policy for maximum performance; and
using the first spin-rate if the determining identifies a policy for maximum battery life.

23. A method according to claim 22, the affecting further comprises using the first spin-rate if the determining identifies a policy for quiet operation.

24. A method according to claim 20, further comprising:
determining a power source; and
selecting a spin-rate for the optical disk dependent on determining of the power source.

25. A method according to claim 24, in which the selecting comprises:
using the first spin rate for the optical disk if the determining determines a battery as the power source; and
using a second spin-rate otherwise.

26. A computer system comprising:
a processor;
a graphics controller;
a sound controller;
an optical disk drive operable to read data from an optical disk and to transfer the data to at least one of the processor, the graphics controller and the sound controller;
a power source to source power to at least the optical disk drive; and
a rotational governor to establish a rotational speed of an optical disk within the optical disk drive based on at least one of a type of data transfer associated with a data-transfer-request, a configuration policy of the processor, and a power source of the power supply.

27. A computer system according to claim 26, further comprising:
a register to contain configuration information;
the rotational governor to establish the rotational speed dependent on the configuration information within the registers.

28. A computer system according to claim 27, in which the processor comprises an operating system operable to:
determine if the power source comprises a battery; and
set configuration data in the registers dependent on the determination of a battery type power source.

29. A computer system according to claim 27, in which the processor system is operable to:
determine at least one of a configuration policy of the computer and data-transfer types associated with requests to access the optical drive; and
set configuration data in the registers dependent on at least one of the determined configuration policy and determined data-transfer types.

30. A computer system according to claim 26, the rotational governor operable to set the rotational speed to a real-time data transfer rate for real-time audio/video reproduction responsive to determinations of autonomous audio/video data streaming applications.
